(19) United States
(12) Patent Application Publication
(10) Pub. No.: US 2017/0188220 A1
(43) Pub. Date: Jun. 29, 2017

(54) PROXIMITY-BASED COMMUNICATIONS, NETWORK ASSISTED DEVICE DISCOVERY

(71) Applicant: NOKIA SOLUTIONS AND NETWORKS OY, Espoo (FI)

(72) Inventors: Patrick MARSCH, Wroclaw (PL); Ali YAVER, Rawalpindi (PK); Fernando SANCHEZ MOYA, Wroclaw (PL)

(21) Appl. No.: 15/314,336

(22) PCT Filed: May 30, 2014
(86) PCT No.: PCT/EP14/61230

§ 371 Date: Nov. 28, 2016

(51) Int. Cl. H04W 8/00; H04L 5/00; H04W 76/02

(52) U.S. Cl. CPC H04W 8/005; H04W 76/023; H04L 5/0057; H04W 88/08

(57) ABSTRACT

Example implementations are related to an apparatus, including: at least one processor and at least one memory including a computer program code, the at least one memory and the computer program code configured to, with the at least one processor, cause the apparatus at least to: control transmitting, by a network node, to a first user terminal instructions to carry out an uplink transmission to the network node or another network node, control transmitting to a second user device instructions to carry out a decoding process to the transmission and initiate a device-to-device communications between the first user terminal and the second user terminal, if the second user terminal is able to decode the transmission and if the second user terminal is able to provide feedback information to the first user terminal.

### FIELD OF THE INVENTION

The exemplifying and non-limiting embodiments of this invention relate generally to wireless communications networks, and more particularly to device-to-device communications.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Infrastructure-facilitated device-to-device communications, (D2D) communications (both in-band and out-band) are expected to be an integral aspect of future wireless communications systems. In order to utilize direct D2D communication, it is so far typically required that the devices first discover each other, signal this proximity information to the infrastructure which then potentially makes a decision to enable direct D2D communication and send corresponding scheduling grants to the devices.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, an apparatus, and a computer program product as defined in the independent claims. Further embodiments of the invention are disclosed in the dependent claims.

An aspect of the invention relates to a method comprising: controlling transmitting to a first user terminal instructions to carry out a transmission, controlling transmitting to a second user device instructions to carry out a decoding process to the transmission and initiating a device-to-device communications between the first user terminal and the second user terminal, if the second user terminal is able to decode the transmission and if the second user terminal is able to provide feedback information to the first user terminal.

A further aspect of the invention relates to a method comprising: controlling receiving, by a first user terminal, instructions from a network node to carry out a transmission to the same or another network node, controlling transmitting the transmission to the same or another network node, and controlling receiving an acknowledgement message for the transmission and carrying out a first decoding process to the received acknowledgement message, and/or controlling receiving a transmission from the second user terminal and carrying out a second decoding process to the received transmission, and controlling transmitting an indication on readiness to device-to-device communications to the network node based on the first decoding process and/or on the second decoding process.

A still further aspect of the invention relates to method comprising:
controlling receiving, by a second user terminal, instructions from a network node to carry out a decoding process to a transmission from a first user device to the same or another network node, controlling receiving the transmission, and carrying out a decoding process to the received transmission.

A further aspect of the invention relates to an apparatus, comprising: at least one processor and at least one memory including a computer program code, the at least one memory and the computer program code configured to, with the at least one processor, cause the apparatus at least to: control transmitting to a first user terminal instructions to carry out a transmission, control transmitting to a second user device instructions to carry out a decoding process to the transmission and initiate a device-to-device communications between the first user terminal and the second user terminal, if the second user terminal is able to decode the transmission and if the second user terminal is able to provide feedback information to the first user terminal.

A still further aspect of the invention relates to apparatus comprising: at least one processor and at least one memory including a computer program code, the at least one memory and the computer program code configured to, with the at least one processor, cause the apparatus at least to: control receiving, by a first user terminal, instructions from a network node to carry out a transmission to the same or another network node, control transmitting the transmission to the same or another network node, and control receiving an acknowledgement message for the transmission and carrying out a first decoding process to the received acknowledgement message, and/or control receiving a transmission from the second user terminal and carrying out a second decoding process to the received transmission, and control transmitting an indication on readiness to device-to-device communications to the network node based on the first decoding process and/or on the second decoding process.

A still further aspect of the invention relates to an apparatus comprising: at least one processor and at least one memory including a computer program code, the at least one memory and the computer program code configured to, with the at least one processor, cause the apparatus at least to: control receiving, by a second user terminal, instructions from a network node to carry out a decoding process to a transmission from a first user device to the same or another network node, control receiving the transmission, and carry out a decoding process to the received transmission.

A still further aspect of the invention relates to an apparatus comprising means for controlling transmitting to a first user terminal instructions to carry out a transmission, means for controlling transmitting to a second user device instructions to carry out a decoding process to the transmission and means for initiating a device-to-device communications between the first user terminal and the second user terminal, if the second user terminal is able to decode the transmission and if the second user terminal is able to provide feedback information to the first user terminal.

A still further aspect of the invention relates to an apparatus comprising means for controlling receiving, by a first user terminal, instructions from a network node to carry out a transmission to the same or another network node, means for controlling transmitting the transmission to the same or another network node, and means for controlling receiving an acknowledgement message for the transmission and means for carrying out a first decoding process to the received acknowledgement message, and/or means for controlling receiving a transmission from the second user terminal and means for carrying out a second decoding process to the received transmission, and means for controlling transmitting an indication on readiness to device-to-device communications to the network node based on the first decoding process and/or on the second decoding process.

A still further aspect of the invention relates to an apparatus comprising means for controlling receiving, by a second user terminal, instructions from a network node to carry out a decoding process to a transmission from a first user device to the same or another network node, means for controlling receiving the transmission, and means for carrying out a decoding process to the received transmission.

A still further aspect of the invention relates to a computer program embodied on a computer-readable storage medium, the computer program comprising program code for controlling a process to execute a process, the process comprising: controlling transmitting to a first user terminal instructions to carry out a transmission, controlling transmitting to a second user device instructions to carry out a decoding process to the transmission and initiating a device-to-device communications between the first user terminal and the second user terminal, if the second user terminal is able to decode the transmission and if the second user terminal is able to provide feedback information to the first user terminal.

A still further aspect of the invention relates to a computer program embodied on a computer-readable storage medium, the computer program comprising program code for controlling a process to execute a process, the process comprising: controlling receiving, by a first user terminal, instructions from a network node to carry out a transmission to the same or another network node, controlling transmitting the transmission to the same or another network node, and controlling receiving an acknowledgement message for the trans-mission and carrying out a first decoding process to the received acknowledgement message, and/or controlling receiving a transmission from the second user terminal and carrying out a second decoding process to the received transmission, and controlling transmitting an indication on readiness to device-to-device communications to the network node based on the first decoding process and/or on the second decoding process.

A still further aspect of the invention relates to a computer program embodied on a computer-readable storage medium, the computer program comprising program code for controlling a process to execute a process, the process comprising: controlling receiving, by a second user terminal, instructions from a network node to carry out a decoding process to a transmission from a first user device to the same or another network node, controlling receiving the transmission, and carrying out a decoding process to the received transmission.

A still further aspect of the invention relates to a computer program product for a computer, comprising software code portions for performing, when said product is run on the computer the steps of: controlling transmitting to a first user terminal instructions to carry out a transmission, controlling transmitting to a second user device instructions to carry out a decoding process to the transmission and initiating a device-to-device communications between the first user terminal and the second user terminal, if the second user terminal is able to decode the transmission and if the second user terminal is able to provide feedback information to the first user terminal.

A still further aspect of the invention relates to a computer program product for a computer, comprising software code portions for performing, when said product is run on the computer the steps of: controlling receiving, by a first user terminal, instructions from a network node to carry out a transmission to the same or another network node, controlling transmitting the transmission to the same or another network node, and controlling receiving an acknowledgement message for the transmission and carrying out a first decoding process to the received acknowledgement message, and/or controlling receiving a transmission from the second user terminal and carrying out a second decoding process to the received transmission, and controlling transmitting an indication on readiness to device-to-device communications to the network node based on the first decoding process and/or on the second decoding process.

A still further aspect of the invention relates to a computer program product for a computer, comprising software code portions for performing, when said product is run on the computer the steps of: controlling receiving, by a second user terminal, instructions from a network node to carry out a decoding process to a transmission from a first user device to the same or another network node, controlling receiving the transmission, and carrying out a decoding process to the received transmission.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplifying embodiments with reference to the attached drawings, in which

FIG. 1 shows an example of system architecture;

FIG. 2 illustrates an exemplifying setup of D2D communication;

FIG. 3 illustrates a situation where D2D transmission may not be successful;

FIGS. 4-6 depict schematic diagrams of flow charts according to exemplifying embodiments of the invention;

FIGS. 7-10 illustrate signalling flows regarding some embodiments (variants A, B, C and D);

FIG. 11 shows a messaging diagram illustrating an exemplifying messaging event according to an embodiment of the invention;

FIG. 12 shows a simplified block diagram illustrating examples of apparatuses.

### DETAILED DESCRIPTION OF SOME EMBODIMENTS

Exemplifying embodiments of the present invention will now be described more specifically hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

Embodiments of the present invention are applicable to any user terminal, server, corresponding component, and/or to any communication system or any combination of different communication systems that support device-to-device communications. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be ap-plied, an architecture based on LTE/LTE-A (long term evolution/long term evolution advanced) or 5G (5^{th} generation) network elements, without restricting the embodiment to such an architecture, however. The embodiments described in these examples are not limited to the LTE/LTE-A or 5G radio systems but can also be implemented in any other radio system, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as B4G/5G, LTE/LTE-A and UMTS.

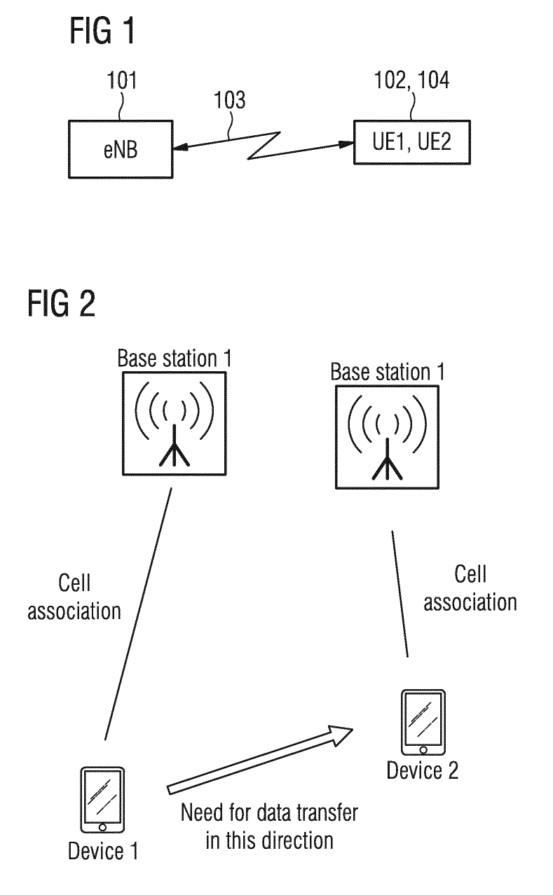

An example of a general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for D2D communication, are irrelevant to the actual invention. Therefore, they need not to be discussed in more detail here.

The exemplifying radio system of FIG. 1 comprises a network node 101 of a network operator. The network node 101 may include e.g. a 5G or LTE-A base station eNB of a cell, radio network controller (RNC), or any other network element, or a combination of network elements. The network node 101 may be connected to one or more core network (CN) elements (not shown in FIG. 1) such as a mobile switching centre (MSC), MSC server (MSS), mobility management entity (MME), serving gateway (SGW), gateway GPRS (general packet radio service) support node (GGSN), serving GPRS support node (SGSN), home location register (HLR), home subscriber server (HSS), visitor location register (VLR). In FIG. 1, the radio network node 101 that may also be called eNB (enhanced node-B, evolved node-B) or network apparatus of the radio system, hosts the functions for radio resource management in the second cell of a public land mobile network.

FIG. 1 shows a user device, user terminal or user equipment (UE) 102, 104 located in the service area of the radio network node 101. The user device or terminal refers to a portable computing device. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer, phablet, tablet, or any other device capable to radio communications. In device-to-device communications, a user terminal may also be a machine-type communications device.

In the example situation of FIG. 1, the user terminal 102 is capable of connecting to the radio network node 101 via a (cellular radio) connection 103, respectively.

An exemplifying embodiment is related to a process of establishing a device-to-device service (D2D) communications link, between devices which are under network coverage. Typically, devices first discover whether they are in proximity to each other before a D2D link can be established, whereas an exemplifying embodiment only requires the network to have very rough information available on whether the devices are in proximity, and may yet enable seamless switching from device-infrastructure-device communication to direct D2D communication. The discovery process may require a lot of resources (e.g. orthogonal pilot sequences among a large number of devices in proximity) and/or take a long time. The overall process is lengthy and requires multiple times information exchange between devices and infrastructure or vice versa.

Exemplifying embodiments are related to a process of initiating proximity based communications in a way only requiring a network to have rough information on whether two (or more) devices are in the proximity of each other.

FIG. 2 illustrates an exemplifying setup of D2D communications. Let us assume a network constellation as depicted in FIG. 3. The two depicted devices may be assigned to the same cell or different cells. Further, many more cells may exist, or many more devices may be assigned to the depicted and other cells, but these are omitted herein for reasons of clarity. Embodiments may also be applicable to a situation where device 1 and device 2 are associated to the same base station or (network) node.

Let us further assume as an example a situation, wherein the device 1 or first user terminal has a need to send data to the device 2 or a second user terminal, and that this need is known to the cell or cells which the two devices are assigned to. Embodiments may also be applied in the case where the roles of the two devices are swapped, or where both devices simultaneously need to exchange data, but these cases are omitted herein for the sake of clarity.

Let us further assume that the involved cell(s) have rough information that the two devices may be in a proximity close enough to allow for direct D2D communication. This information may, for instance, be obtained through interference footprints of the devices (i.e. the information about how strongly different near-by cells receive the two devices), global positioning system (GPS) information from the devices, or any other information source. An exemplifying embodiment also works without the need of any proximity or location information.

FIG. 3 illustrates an example of a case, wherein device-to-device communications may not succeed, as a first user terminal may not be able to decode required feedback information (e.g. hybrid automatic repeat request (HARQ) feedback, acknowledgement/no-acknowledgement (ACK/NACK), power control etc.) transmitted from a second user terminal. For a successful transmission, a receiving device has typically to manage to decode the received data transmission, and a transmitting device should be able to decode possible feedback information (e.g. ACK/NACK signalling, power control commands etc.). FIG. 3 illustrates an example, wherein this may be an issue, as allowed transmission power of the transmitting device (device 1) is much higher than that of the receiving device (device 2).

In an embodiment, as simplified, a data transmission from a first user terminal to its assigned base station is triggered. It is probed or tested whether a second user terminal is able to successfully decode this transmission and to provide feedback information to the first user terminal. If both of these conditions are fulfilled, further communication between these user terminals takes place over an established direct communications link. If at least one of these two conditions is not fulfilled, communications between the devices continues to take place in the device-infrastructure-device fashion (i.e. as in a conventional cellular network). It should be appreciated that a network under the area the devices are located, may decide to re-probe or retest the communication link or quality of service.

Switching back from a successfully established device-to-device communications mode to a device-infrastructure-device communications mode may be based on any suitable criterion (e.g. when a quality metric of the link is not met) and any other suitable technique.

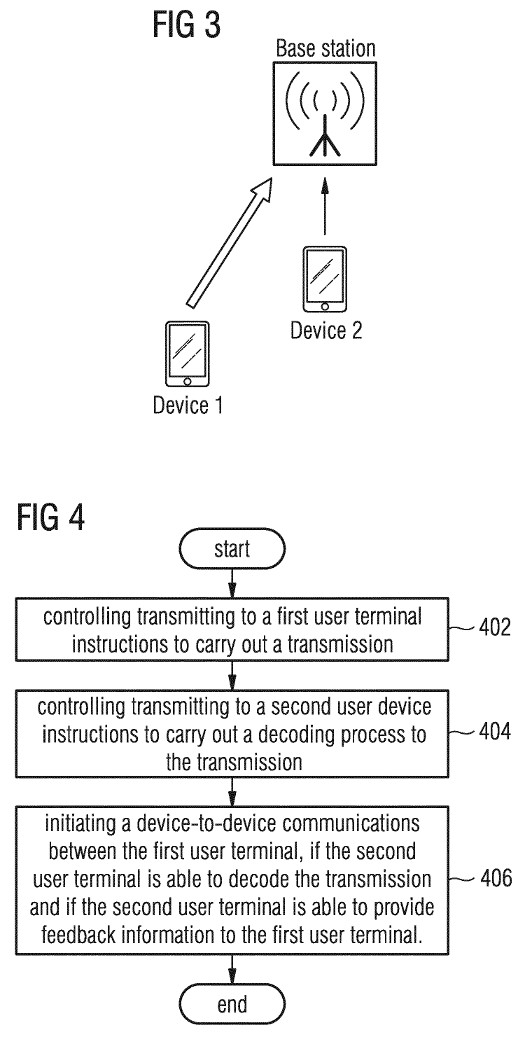

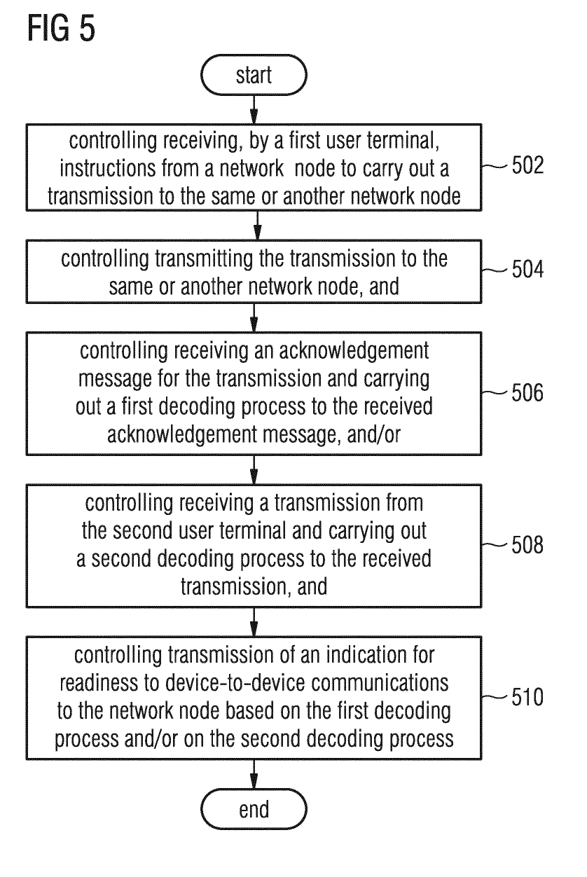

FIG. 4 is a flow chart illustrating an exemplifying embodiment.

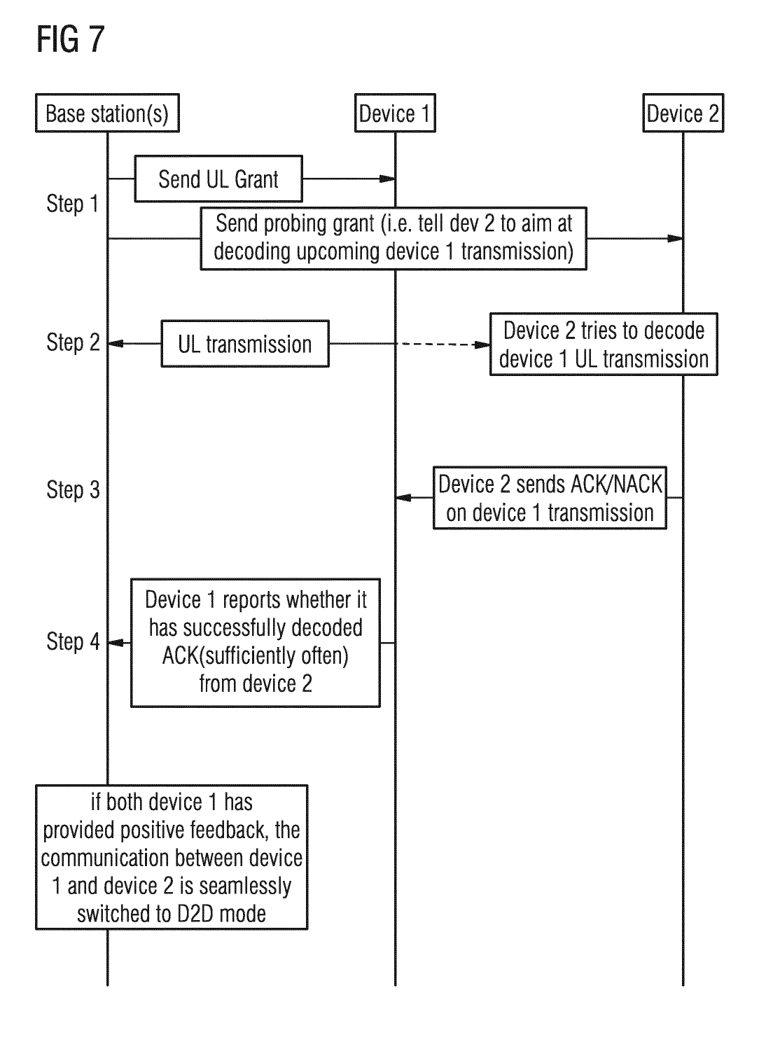

This embodiment is suitable to be carried out in/by a network node, base station, server or host. Further details are provided below by means of FIGS. 7 to 10. In the FIGS. 7 to 10, device 1 means a first user device and device 2 means a second user device.

In block 402, transmitting instructions to a first user terminal to carry out a transmission is controlled. In the embodiments below, these instructions may be conveyed in the form of a grant message instructing to perform an uplink transmission in the upcoming scheduling interval. The first user device is the one having a need to transmit data.

It should be appreciated that, typically, the transmission is an ordinary data transmission to a node, which the other user terminal tries to decode. In this case, if the device-to-device link fails, the communication still takes place as a device-infrastructure-device communication without an interruption.

In block 404, transmitting instructions to a second user device to carry out a decoding process to the transmission is controlled.

In the embodiments below, these instructions may be conveyed in a form of a grant message instructing to try to decode the upcoming transmission from the first user device. The instructions may also comprise the information required (e.g. modulation and coding scheme, used resources etc.). It should be appreciated that typically, no power control or HARQ process is attached to these instructions to make the second user device to be able to recognize that this is for testing purposes only.

In block 406, a device-to-device communications between the first user terminal and the second user terminal is initiated, if the second user terminal is able to decode the transmission and if the second user terminal is able to provide feedback information to the first user terminal.

An option to providing the second user terminal with information on the difference in the maximum transmission power between the first user device and the second user device also exists.

The feedback information may include at least one of the following: acknowledgement signalling, negative acknowledgement signalling, precoding signalling, channel quality indicator feedback signalling, rank adaptation signalling and power control signalling.

FIG. 5 is a flow chart illustrating an exemplifying embodiment. This embodiment is suitable to be carried out in/by a user terminal or user device. Further details are provided below by means of FIGS. 7 to 10. In the FIGS. 7 to 10, device 1 means a first user device and device 2 means a second user device.

In block 502, receiving of instructions from a network node to carry out a transmission to the same or another network node is controlled.

It should be appreciated that, typically, the transmission is an ordinary data transmission to a node, which the other user terminal tries to decode. In this case, if the device-to-device link fails, the communication still takes place as a device-infrastructure-device communication without an interruption.

It should be understood that user terminals involved may be assigned to different network nodes or to a same network node.

In the embodiments below, these instructions may be conveyed in the form of a grant message instructing to perform an uplink transmission in the upcoming scheduling interval.

In block 504, transmitting the transmission to the same or another network node is controlled.

In block 506, receiving of an acknowledgement (ACK) message for the transmission is controlled and a first decoding process to the received acknowledgement message is carried out,

In block 508, in addition to or as an option for 504, receiving of a transmission from the second user terminal is controlled and a second decoding process to the received transmission is carried out, and

In block 510, transmitting an indication on readiness to device-to-device communications to the network node based on the first decoding process and/or on the second decoding process is controlled.

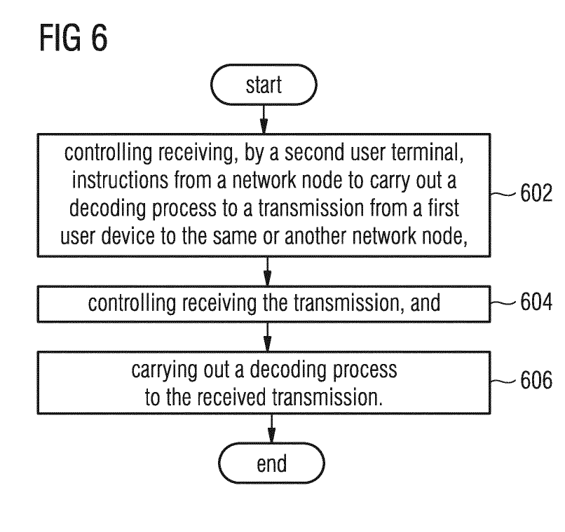

FIG. 6 is a flow chart illustrating an exemplifying embodiment.

This embodiment is suitable to be carried out in/by a user terminal or user device. Further details are provided below by means of FIGS. 7 to 10. In the FIGS. 7 to 10, device 1 means a first user device and device 2 means a second user device.

In block 602, receiving instructions from a network node to carry out a decoding process to a transmission from a first user terminal to the same or another network node is controlled.

It should be appreciated that, typically, the transmission is an ordinary data transmission to a node, which the other user terminal tries to decode. In this case, if the device-to-device link fails, the communication still takes place as a device-infrastructure-device communication without an interruption.

It should be understood that user terminals involved may be assigned to different network nodes or to a same network node.

These instructions may be conveyed in a form of a grant message instructing to try to decode the upcoming transmission from the first user device. The instructions may also comprise the information required (e.g. modulation and coding scheme, used resources etc.). It should be appreciated that typically, no power control or HARQ process is attached to these instructions to make the second user device to be able to recognize that this is for testing purposes only.

In block 604, receiving the transmission from the first user terminal is controlled.

In block 606, a decoding process to the received transmission is carried out.

It is also an option to provide feedback information on the decoding process to the first user device. The feedback information may include at least one of the following: acknowledgement signalling, negative acknowledgement signalling, precoding signalling, channel quality indicator feedback signalling, rank adaptation signalling and power control signalling.

As an yet further option, the instruction may further comprise information on the difference in the maximum transmission power between the first user device and the second user device, in which case, based on the information on the difference in the maximum transmission power between the first user device and the second user device, and potentially further information connected to the decoding of the transmission from device 1 (e.g. signal-to-interference and noise ratio), it may be determined that the first user device is able to receive the feedback information.

In yet another alternative, receiving instructions from the network node to transmit a test acknowledgment to the first user terminal is controlled, and the transmission of the test acknowledgement is controlled. The transmission of the test acknowledgement may take place in a same time interval than the transmission.

Additionally, transmission of an indication for readiness to device-to-device communications to the network node may be controlled.

The steps/points, signalling messages and related functions de-scribed above in FIGS. 4 to 6 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplifying and may even comprise several separate messages for transmitting the same information. In addition, the messages may also contain other information.

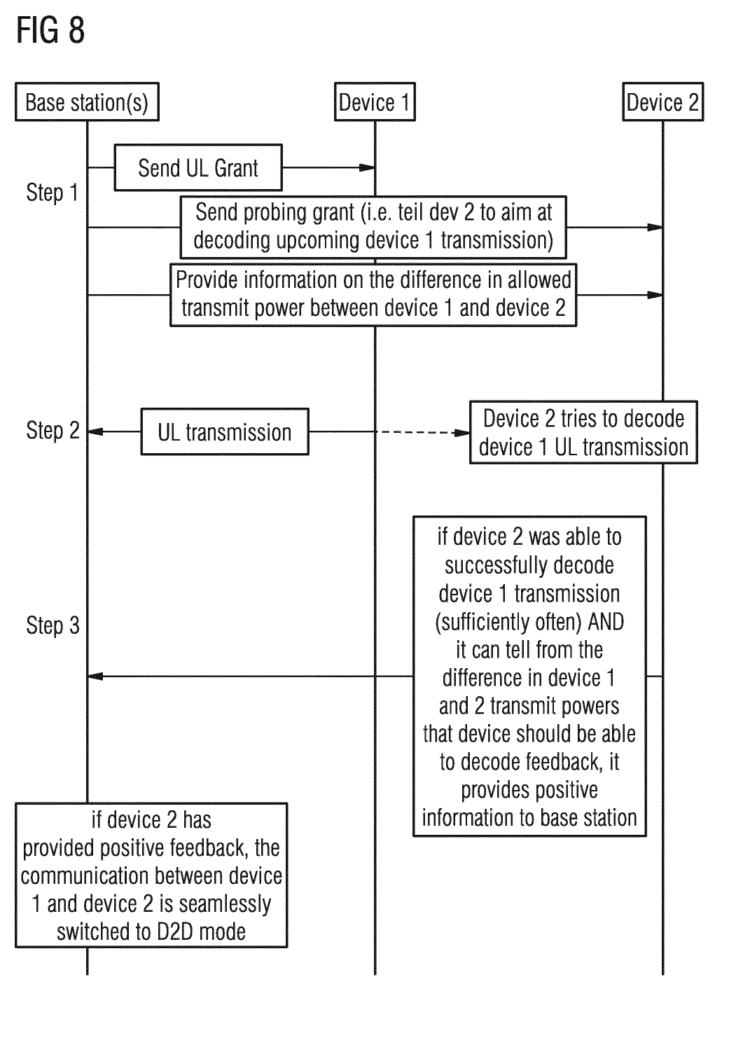

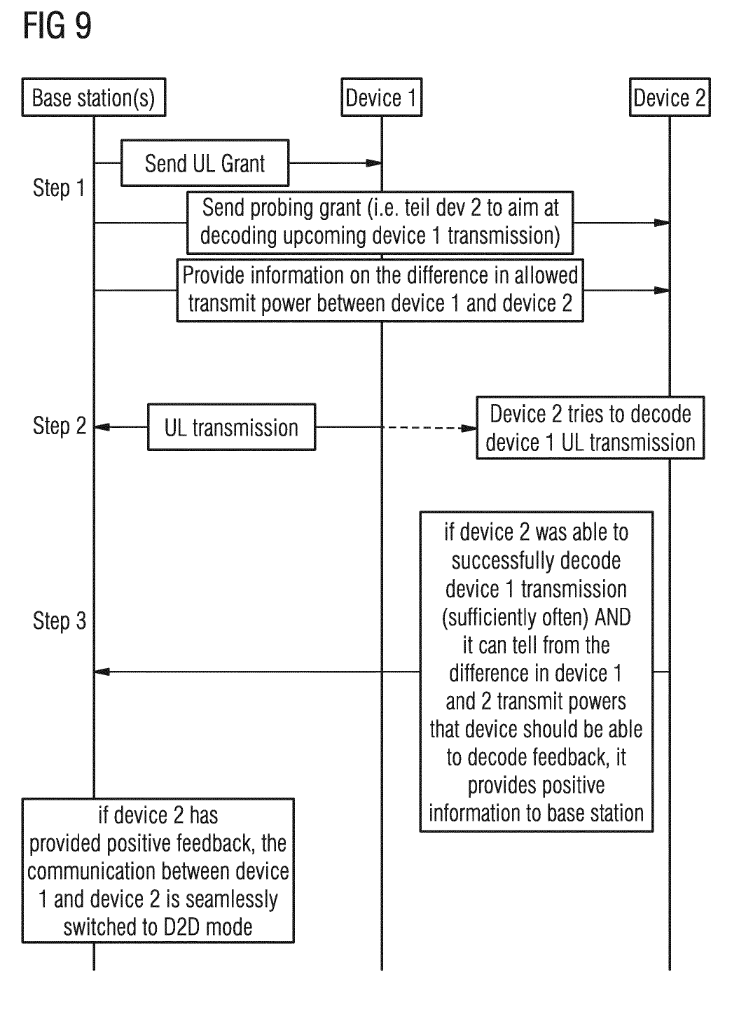

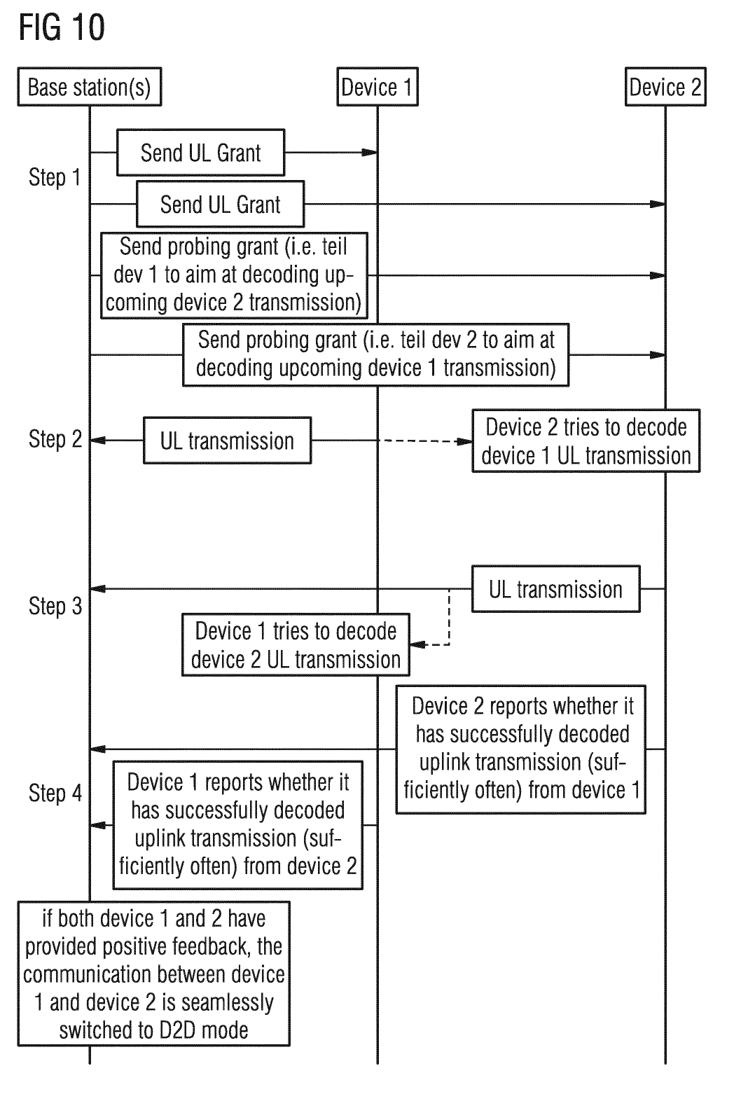

In the following, some examples of methods disclosed above by means of flow charts 4 to 6 are disclosed in further detail. The details are not limiting, but are presented herein only for clarification purposes. These examples are studied by means of FIGS. 7 to 10. FIG. 7 illustrates variant (embodiment) A, FIG. 8 illustrates variant (embodiment) B, FIG. 9 illustrates variant (embodiment) C, and FIG. 10 illustrates variant (embodiment) D.

Typically in the following examples, the communication is switched to device-to-device communications, if it can be expected to be reliable enough in terms that a) a transmission target device is able to successfully receive data transmissions from a transmission source device and b) the transmission source device is able to successfully decode required feedback information (e.g. HARQ information, ACK/NACK signalling, power control commands, pre-coding signalling, channel quality indicator (CQI) feedback, etc.) transmitted from the transmission target device.

### First Embodiment, (Variant A in Figures)—Testing D2D Data Transmission and the Corresponding Feedback Channel Before Switching to D2D Transmission

1 a) a base station (network node, such as an eNodeB) to which device 1 is assigned sends a grant to device 1, instructing device 1 to attempt performing of an uplink transmission in the upcoming scheduling interval.
1b) The base station (network node) to which device 2 is assigned sends a grant to device 2 instructing device 2 to try to decode the upcoming transmission from device 1 triggered in step 1a), and comprising the information device 2 requires to do so (e.g. modulation and coding scheme of the transmission of device 1, used resources etc.). Device 2 needs to be able to tell from this grant that this is for probing purposes only, i.e. that there is no power control or HARQ process attached to this.
2) Device 1 performs the scheduled transmission, and both the base station (as in a usual data transmission from the device to the base station) and device 2 try to decode this. The transmission presumably is subject to a HARQ process and power control between device 1 and its assigned base station, but this is not necessarily the case.
3) Device 2 transmits an acknowledgement if it succeeded decoding device 1 in step 2), and device 1 tries to receive this
4a) If device 1 successfully decodes an acknowledgement from device 2 (or if it successfully decodes acknowledgements from device 2 during a defined percentage of successive probing attempts), it signals to its assigned BS that the communication between devices 1 and 2 may now switch to direct device-to-device communication. This D2D communication is then presumably subject to a power control and HARQ process between the two devices, but this is not necessarily the case.
4b) If, however, device 1 does not successfully decode an acknowledgement from device 2 (or if device 1 does not successfully decode enough acknowledgements from device 2 over a series or successive probing attempts), the communication between device 1 and device 2 remains as device-infrastructure-device communication. The system may decide to repeat the probing process at any time/interval by starting point 1a) again.

### Second Embodiment, (Variant B)—Shorter Version where the Feedback Channel is not Explicitly Tested

1a) a base station to which device 1 is assigned sends a grant to device 1, instructing device 1 to perform an uplink transmission in the upcoming scheduling interval.
1b) The base station to which device 2 is assigned sends a grant to device 2 instructing the device to try to decode the upcoming transmission from device 1 triggered in step 1a), and comprising the information device 2 requires to do so (e.g. modulation and coding scheme of the transmission of device 1, used resources etc.). Device 2 needs to be able to tell from this grant that this is for probing purposes only, i.e. that there is no power control or HARQ process attached to this.
1c) The base station to which device 2 is assigned also provides the device 2 with information on the difference in the maximum usable absolute transmit power of device 1 and device 2. This may, for instance, be the difference in transmit power on a logarithmic scale, quantized to a few bits of information.
2) Device 1 performs the scheduled transmission, and both the base station (as in a usual data transmission from the device to the base station) and device 2 try to decode this. The transmission is presumably subject to a HARQ process and power control between device 1 and its assigned base station, but this is not necessarily the case.
3a) If device 2 is able to successfully decode the transmission from device 1 (or it achieves a certain success rate over multiple successive probing attempts) AND it is able to judge from the provided information on the difference in the transmit power between device 1 and device 2 that device 1 is also (with a certain probability) able to successfully decode feedback information in a direct D2D communication, device 2 signals to its assigned base station that one may switch into the direct D2D communication mode. At the same time, device 2 may signal an acknowledgment to device 1.
3b) If device 2 is not able to successfully decode the transmission from device 1 (or if device 2 does not achieve a certain success rate over multiple successive probing attempts), or if device 2 concludes from the provided information on the transmit power difference between device 1 and device 2 that device 1 is not able to decode the D2D feedback at a sufficient probability, the communication between device 1 and device 2 remains in the device-infrastructure-device mode. The system may decide at any time/interval to again probe whether direct D2D communication between device 1 and device 2 is possible by restarting the process at 1a).

### Third Embodiment, (Variant C)—Shorter Version where the Feedback Channel is Explicitly Tested Via a “Test Acknowledgement”. The Test Acknowledgement is Typically Transmitted in Parallel to the Data Transmission

1 a) a base station to which device 1 is assigned sends a grant to device 1, instructing device 1 to perform an uplink transmission in the upcoming scheduling interval.
1b) The base station to which device 2 is assigned sends a grant to device 2 instructing device 2 to try to decode the upcoming transmission from device 1 triggered in step 1a), and comprising the information device 2 requires to do so (e.g. modulation and coding scheme of the transmission of device 1, used resources etc.). Device 2 needs to be able to tell from this grant that this is for probing purposes only, i.e. that there is no power control or HARQ process attached to this.
2a) Device 1 performs the scheduled transmission, and both the base station (as in a usual data transmission from the device to the base station) and device 2 try to decode this. The transmission is presumably subject to a HARQ process and power control between device 1 and its assigned BS, but this is not necessarily the case.
2b) Device 2 in the same scheduling interval sends any form of “test acknowledgement” which device 1 attempts to decode. This may be any signalling which the device anyway performs, or additional signalling may be introduced for this purpose.
3a) If device 2 is able to successfully decode the transmission from device 1 (or it achieves a certain success rate over multiple successive probing attempts), device 2 signals a positive indication to its assigned base station.
3b) If device 1 is able to successfully decode the “test acknowledgement” from device 2 (or it achieves a certain success rate over multiple attempts), device 1 signals a positive indication to its assigned base station.

If the involved base stations receive positive indications from both devices, the communication between the devices may be switched into direct D2D mode, otherwise device-infrastructure-device prevails. As in each previous variant, the system may decide at any time instance/interval to probe the possibility of direct D2D communication between device 1 and device 2 again by starting the process from point 1a).

### Fourth Embodiment (Variant D)—Variant D May be Resource Intensive Compared to Other Variants but it May Make the Implementation Simpler Since Both UEs are Required to Perform Similar Actions

1a) q base station to which device 1 is assigned sends a grant to device 1, instructing device 1 to perform an uplink transmission in the upcoming scheduling interval.
1b) The base station to which device 2 is assigned sends a grant to device 2, instructing device 2 to perform an uplink transmission in the upcoming scheduling interval.
1c) The base station to which device 2 is assigned sends a grant to device 2 instructing device 2 to try to decode the upcoming transmission from device 1 triggered in step 1a), and comprising the information device 2 requires to do so (e.g. modulation and coding scheme of the transmission of device 1, used resources etc.). Device 2 needs to be able to tell from this grant that this is for probing purposes only, i.e. that there is no power control or HARQ process attached to this.
1d) The base station to which device 1 is assigned sends a grant to device 1 instructing device 1 to try to decode the upcoming transmission from device 2 triggered in step 1b), and comprising the information device 1 requires to do so (e.g. modulation and coding scheme of the transmission of device 1, used resources etc.). Device 1 needs to be able to tell from this grant that this is for probing purposes only, i.e. that there is no power control or HARQ process attached to this.
2) Device 1 performs the scheduled transmission, and both the BS (as in a usual data transmission from device to base station) and device 2 try to decode this. The transmission is presumably subject to a HARQ process and power control between device 1 and its assigned BS, but this is not necessarily the case.
3) Device 2 performs the scheduled transmission, and both the BS (as in a usual data transmission from device to base station) and device 1 try to decode this. The transmission is presumably subject to a HARQ process and power control between device 2 and its assigned BS, but this is not necessarily the case.
4a) If both devices successfully decode each other's UL transmission (or if they successfully decode transmissions during a defined percentage of successive probing attempts), they signal to their assigned base station(s) that the communication between device 1 and device 2 may now switch to direct device-to-device communication. This D2D communication is then presumably subject to a power control and HARQ process between the two devices, but this is not necessarily the case.
4b) If, however, one of the devices does not successfully decode a transmission (or if it does not successfully decode transmissions over a series or successive probing attempts), the communication between device 1 and device 2 remains as device-infrastructure-device communication. The system may decide to repeat the probing process at any time/interval by starting point 1a) again.

In each of the presented variants A, B C and/or D, the feedback channel from device 2 to device 1 may be subject to a boosting of the transmit power, in order to reduce the likelihood that device 1 is not able to decode the feedback information from device 2, even though device 2 is able to decode the data transmission of device 1.

Usually, actions considered to be carried out in one “step” may be carried out in one scheduling interval—it should be appreciated that depending on the actual physical layer implementation, design of control channels etc., actions taking place in one “step” may be simultaneous or not.

Embodiments or variants are applicable regardless of whether device 1 and device 2 are assigned to the same network node. If they are assigned to multiple network nodes or different network nodes, additional signalling between the nodes is usually needed, for example for enabling cooperation between nodes.

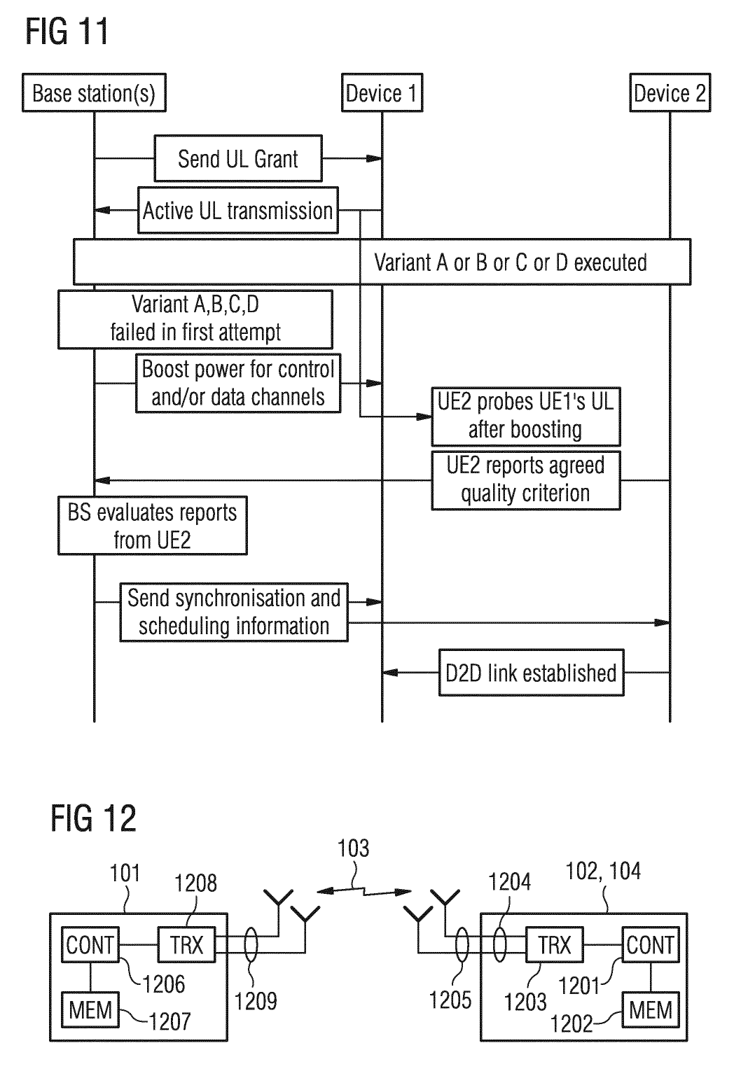

FIG. 11 illustrates a channel boosting option (applicable to each of embodiments or variants). FIG. 11 illustrates an exemplifying signalling flow in the case conditions for device-to-device communications have not been met and thus a need to boost the channel (such as to amplify transmission signal) for the device or user terminal in a shorter distance of the node exists.

In the embodiment described above, no detailed device-to-device discovery is required.

FIG. 12 is a block diagram of an example of an apparatus according to an embodiment of the invention. The apparatus may operate as a first user terminal (device 1) and/or as a second user terminal (device 2). FIG. 12 shows a user terminal 102, 104 located in the area of a radio network node 101. The user terminal 102, 104 is configured to be in connection 103 with the radio network node 101. The user terminal or UE1 102, UE2 104 comprises a controller 1201 operationally connected to a memory 1202 and a transceiver 1203 (or it is operationally coupled to one). The controller 1201 controls the operation of the user terminal 102, 104 and it is capable to carry out or control functions described above in relation to FIGS. 5 and/or 6. The memory 1202 is configured to store software and data. The transceiver 1203 is configured to set up and maintain a wireless connection 103 to the radio network node 101, respectively. The transceiver 1203 is operationally coupled to a set of antenna ports 1204 connected to an antenna arrangement 1205. The antenna arrangement 1205 may comprise a set of antennas. The number of antennas may be one to four, for example. The number of antennas is not limited to any particular number. The user terminal 102, 104 may also comprise various other components, such as a user interface, camera, and media player. They are not displayed in the Figure for the sake of simplicity.

The radio network node 101, such as an LTE-Advanced or 5G network node or base station (eNode-B, eNB) comprises a controller 1206 operationally connected to a memory 1207, and a transceiver 1208 (or it is operationally coupled to one). The controller 1206 controls the operation of the radio network node 101 and it is capable to carry out or control functions described above in relation to FIG. 4. The memory 1207 is configured to store software and data. The transceiver 1208 is configured to set up and maintain a wireless connection to the user terminal 102, 104 within the service area of the radio network node 101. The transceiver may also be or comprise a remote radio head. The transceiver 1208 is operationally coupled to an antenna arrangement 1209 which may also a part of a remote radio head. The antenna arrangement 1209 may comprise a set of antennas. The number of antennas may be two to four, for example. The number of antennas is not limited to any particular number. The radio network node 101 may be operationally coupled (directly or indirectly) to another network element of the communication system, such as a further radio network node, radio network controller (RNC), a mobility management entity (MME), a serving gateway (SGW), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface (not shown in FIG. 12). The embodiments are not, however, restricted to the network given above as an example, but a person skilled in the art may apply the solution to other communication networks provided with the necessary properties. For example, the connections between different network elements may be realized with internet protocol (IP) connections.

Another example of an apparatus (network node) comprises means (1206) for controlling transmitting to a first user terminal instructions to carry out a transmission, means (1206) for controlling transmitting to a second user device instructions to carry out a decoding process to the transmission and means (1206) for initiating a device-to-device communications between the first user terminal and the second user terminal, if the second user terminal is able to decode the transmission and if the second user terminal is able to provide feedback information to the first user terminal.

Yet another example of an apparatus (user terminal capable to operate as a first user terminal, device 1) comprises means (1201) for controlling receiving, by a first user terminal, instructions from a network node to carry out a transmission to the same or another network node, means (1201) for controlling transmitting the transmission to the same or another network node, and means (1201) for controlling receiving an acknowledgement message for the transmission and means (1201) for carrying out a first decoding process to the received acknowledgement message, and/or means (1201) for controlling receiving a transmission from the second user terminal and means (1201) for carrying out a second decoding process to the received transmission, and means (1201) for controlling transmission of an indication for readiness to device-to-device communications to the network node based on the first decoding process and/or on the second decoding process.

Yet another example of an apparatus (user terminal capable to operate as a second user terminal, device 2) comprises means (1201) for controlling receiving, by a second user terminal, instructions from a network node to carry out a decoding process to a transmission from a first user device to the same or another network node, means (1201) for controlling receiving the transmission, and means (1201) for carrying out a decoding process to the received transmission.

Although the apparatus 101, 102, 104 has been depicted as one entity, different modules and/or memory may be implemented in one or more physical or logical entities. The apparatus may also be a device that associates, or is arranged to associate, the user terminal and its user with a subscription and allows a user to interact with a communications system. The user terminal presents information to the user and allows the user to input information to the apparatus 101, 102, 104 may generally include a processor, controller, control unit or the like connectable to a memory and to various inter-faces of the apparatus. The processor may be a central processing unit, but the processor may be an additional operation processor as well. The processor may comprise a computer processor, application-specific integrated circuit (ASIC), field-programmable gate array (FPGA), and/or other hardware components that have been programmed in such a way to carry out one or more functions of an embodiment.

The memory 1202, 1207 may include volatile and/or non-volatile memory and typically stores content, data, or the like. For example, the memory 1202, 1207 may store computer program code such as software applications or operating systems, information, data, content, or the like for a processor to perform steps associated with operation of the apparatus in accordance with embodiments. The memory may be, for example, random access memory (RAM), a hard drive, or other fixed data memory or storage device.

Further, the memory, or part of it, may be removable memory detachably connected to the apparatus.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components or modules which, when the program is run, are configured to carry out embodiments according to FIGS. 4-6 and/or the more detailed examples according to FIGS. 7-10 and/or the boosting operation according to FIG. 11. The one or more computer-executable components may be at least one software code or portions of it. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium or on a computer-readable medium, comprising program instructions which, when loaded into electronic apparatuses, constitute the apparatuses as explained above. The distribution medium or the computer-readable medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art. It will be obvious to a person skilled in the art that, as the technology advances, the inventive concept can be implemented in various ways. The invention and its embodiments are not limited to the examples described above but may vary within the scope of the claims.

1. A method comprising:
controlling transmitting, by a network node to a first user terminal, instructions to carry out an uplink transmission to the network node or another network node,
controlling transmitting to a second user device instructions to carry out a decoding process to the transmission, and
initiating a device-to-device communications between the first user terminal and the second user terminal, if the second user terminal is able to decode the transmission and if the second user terminal is able to provide feedback information to the first user terminal.

2.-7. (canceled)

8. A method comprising:
controlling receiving, by a first user terminal, instructions from a network node to carry out a transmission to the same network node or another network node,
controlling transmitting the transmission to the same network node or another network node-, and
controlling receiving an acknowledgement message for the transmission and carrying out a first decoding process to the received acknowledgement message, and/or
controlling receiving a transmission from the second user terminal and carrying out a second decoding process to the received transmission, and
controlling transmitting an indication on readiness to device-to-device communications to the network node based on the first decoding process and/or on the second decoding process.

9. (canceled)

10. A method comprising:
controlling receiving, by a second user terminal, instructions from a network node to carry out a decoding process to a transmission from a first user device to the same network node or another network node,
controlling receiving the transmission from the first user device to the same network node or another network node,
carrying out a decoding process to the received transmission, and
performing, by the second user terminal, a device-to-device communications between the first user terminal and the second user terminal.

11.-18. (canceled)

19. An apparatus, comprising: at least one processor and at least one memory including a computer program code, the at least one memory and the computer program code configured to, with the at least one processor, cause the apparatus at least to:
control transmitting, by a network node, to a first user terminal instructions to carry out an uplink transmission to the network node or another network node,
control transmitting to a second user device instructions to carry out a decoding process to the transmission, and
initiate a device-to-device communications between the first user terminal and the second user terminal, if the second user terminal is able to decode the transmission.

20. The apparatus according to claim 19, further configured to cause the apparatus to:
decline the device-to-device communications between the first user terminal and the second user terminal, if the second user terminal is not able to decode the transmission and/or if the second user terminal is not able to provide feedback information to the first user terminal.

21. The apparatus according to claim 19, wherein the feedback information comprises at least one of the following: acknowledgement signalling, negative acknowledgement signalling, precoding signalling, channel quality indicator feedback signalling, rank adaptation signalling and power control signalling.

22. The apparatus according to claim 19, further configured to cause the apparatus to:
prior to initiating the device-to-device communications,
control receiving an indication for readiness to device-to-device communications from the first user terminal.

23. The apparatus according to claim 19, further configured to cause the apparatus to:
prior to initiating the device-to-device communications,
provide the second user terminal with information on the difference in the maximum transmission power between the first user terminal and the second user terminal.

24. The apparatus according to claim 19, further configured to cause the apparatus to:
prior to initiating the device-to-device communications,
control receiving an indication for readiness to device-to-device communications from the second user device.

25. The apparatus according to claim 19, further configured to cause the apparatus to:
prior to initiating the device-to-device communications,
carry out a decoding process to the transmission and control receiving an indication for readiness to device-to-device communications from the second user device.

26. An apparatus comprising: at least one processor and at least one memory including a computer program code, the at least one memory and the computer program code configured to, with the at least one processor, cause the apparatus at least to:
control receiving, by a first user terminal, instructions from a network node to carry out a transmission to the same network node or another network node,
control transmitting the transmission to the same network node or another network node, and
control receiving an acknowledgement message for the transmission and carrying out a first decoding process to the received acknowledgement message, and/or
control receiving a transmission from the second user terminal and carrying out a second decoding process to the received transmission, and
control transmitting an indication on readiness to device-to-device communications to the network node based on the first decoding process and/or on the second decoding process.

27. The apparatus according to claim 26, wherein the transmission from the second user terminal is a test acknowledgement for initiating device-to-device communications.

28. An apparatus comprising: at least one processor and at least one memory including a computer program code, the at least one memory and the computer program code configured to, with the at least one processor, cause the apparatus at least to:
control receiving, by a second user terminal, instructions from a network node to carry out a decoding process to a transmission from a first user device to the same network node or another network node,
control receiving the transmission from the first user terminal to the network node or another network node, and
carry out a decoding process to the received transmission, and
perform, by the second user terminal, a device-to-device communications between the first user terminal and the second user terminal.

29. The apparatus according to claim 28, further configured to cause the apparatus to:
provide feedback information on the decoding process to the first user device.

30. The apparatus according to claim 28, wherein being configured to cause the apparatus to carry out the decoding process to the transmission further comprises being configured to cause the apparatus to determine information on a difference in a maximum transmission power between the first user device and the second user device, further configured to cause the apparatus to:
determine based on the information on the difference in the maximum transmission power between the first user device and the second user device that the first user device is able to receive the feedback information, and
control transmission of an indication for readiness to device-to-device communications to the network node.

31. The apparatus according to claim 30, wherein being configured to cause the apparatus to determine the maximum transmission power comprises being configured to cause the apparatus to determine information related to the decoding of the transmission from the first user device.

32. The apparatus according to claim 28, further configured to cause the apparatus to:
control receiving instructions from the network node to transmit a test acknowledgment to the first user terminal,
control transmitting the test acknowledgement to the first user terminal and,
control transmitting of feedback information on the decoding process to the network node.

33. The apparatus according to claim 28, further configured to cause the apparatus to:
control receiving instructions from a network node to carry out a transmission to the first user terminal, and
control transmitting the transmission to the first user terminal, and
control transmitting an indication on readiness to device-to-device communications to the network node based on the decoding process.

34. The apparatus according to claim 29, wherein the feedback information comprises at least one of the following: acknowledgement signalling, negative acknowledgement signalling, precoding signalling, channel quality indicator feedback signalling, rank adaptation and power control signalling.

35.-37. (canceled)
